(19) United States
(12) Patent Application Publication
(10) Pub. No.: US 2011/0094333 A1
(43) Pub. Date: Apr. 28, 2011

(54) Motor vehicle starter with planetary gearset

(76) Inventors: Olivier Chane-Waye, Lyon (FR); Zeng Gang Liu, Maurecourt (FR)

(21) Appl. No.: 10/488,887

(22) PCT Filed: Sep. 16, 2002
(86) PCT No.: PCT/FR2002/003139

§ 371 Date: Feb. 26, 2007

(30) Foreign Application Priority Data
Sep. 14, 2001 (FR) 01/11924

(51) Int. Cl. F02N 15/02; F16H 1/28

(52) U.S. Cl. 74/7 E

(57) ABSTRACT

The motor vehicle starter is provided with a casing (12) and a reduction gear (5) with an epicyclic train comprising a ring (30), provided with an external part (31) and an internal ring part mounted coaxially in the external part, and a monobloc shock damping device (34) interposed between the external reduction gear part (31) and the internal reduction gear ring (32); the casing (12) of the starter having an open end closed by a base plate (35) mounted fixed in the starter and in that the external part (30) of the ring (30) is fixed to the base plate.

### SCOPE

The invention concerns a motor vehicle starter provided with a casing and a reduction gear with an epicyclic train, of the type comprising a ring which comprises an external part mounted fixed in the casing of the starter and an internal part in the form of a ring mounted coaxially in the external part and carrying internal teeth meshing with the planet wheels of the reduction gear, and a device for damping shocks interposed between the external gear part and the internal ring.

### PRIOR ART

A motor vehicle starter of this type is known through the patent FR A 2 514 425. In this starter, the casing in a known manner serves as a housing for the electric motor of the starter, the fixed external part of the gear is formed by a cylindrical housing and the damper device comprises a plurality of damper blocks interposed between the stop projections provided on the internal face of the housing and stop ribs provided on the external peripheral surface of the internal ring.

However, the damper blocks being separate pieces, they must be put in place selectively, which complicates the work of assembling the starter and requires a significant amount of assembly time.

For the purpose of mitigating this drawback a solution was proposed in the document U.S. Pat. No. 4,680,979, in which the damper blocks are arranged in the configuration of a circular ring coaxial with the axis of the reduction gear and a support member and able to be placed between the external gear part and the internal gear ring.

In this document the blocks act between the casing of the electric motor of the starter and the internal ring. To do this the casing is based on aluminium in order to be able to have projections and recesses internally. The size of the internal ring is imposed by the size of the casing. In addition the internal ring has a complex shape.

### OBJECT OF THE INVENTION

The aim of the present invention is to mitigate these drawbacks in a simple and economical manner.

To achieve this aim the starter according to the invention is characterised in that the starter casing has an open end closed by a base plate mounted fixed in the starter and in that the external part of the ring of the reduction gear is fixed to the base plate.

By virtue of the invention a simple and economical solution is obtained and it is possible to choose freely the material of the casing since the latter no longer forms part of the reduction gear ring.

In addition the casing and the internal ring are simplified.

Moreover the size of the external part of the ring is not imposed by the casing and it is possible to give various forms to the damper members and to the external part of the ring.

Thus, according to one characteristic of the invention, the aforementioned support member is formed by a common central element and in that each damper member has the form of an L comprising a damper block extending parallel to the axis of the reduction gear and a radial damper element fixed to the central support.

According to another characteristic of the invention, the support member is formed by a ring on which the damper blocks are mounted as an axial end.

According to yet another characteristic of the invention, the external ring part is formed by a plurality of tenons extending axially from the base plate mounted fixed in the starter and distributed in an angularly equidistant fashion over a circle coaxial with the axis of the reduction gear; the ring of damper blocks being interposed between the external and internal reduction gear ring parts so that a damper block is inserted between a stop rib of the internal reduction gear ring and an external stop ring tenon, resting on the external peripheral face of the internal reduction gear ring.

### BRIEF DESCRIPTION OF THE DRAWINGS

The invention will be better understood, and other aims, characteristics, details and advantages thereof will emerge more clearly from the following explanatory description given with reference to the accompanying schematic drawings given solely by way of example illustrating two embodiments of the invention and in which:

FIG. 1 is a partial view in axial section of a starter of the reduction gear type with epicyclic gear train in the state of the art;

FIGS. 2A and 2B illustrate a first embodiment of a ring device of a reduction gear according to the present invention through views respectively in exploded perspective and in the assembled state;

FIG. 2C is a view in perspective of the rear of the internal reduction gear ring 32 of FIGS. 2A and 2B; and

FIGS. 3A and 3B illustrate a second embodiment of a ring device of a reduction gear according to the present invention, through views respectively in exploded perspective and in the assembled state.

### DESCRIPTION OF EXAMPLE EMBODIMENTS ACCORDING TO THE INVENTION

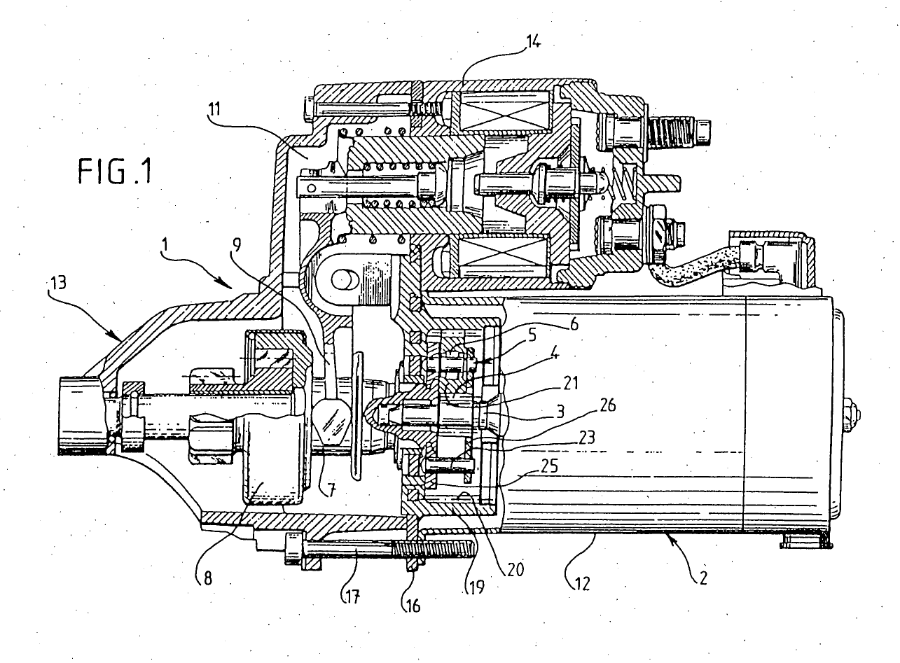

Referring to FIG. 1, a description will be given first of all of a motor vehicle starter 1 equipped with a reduction gear of the epicyclic train type, from the prior art, in order to demonstrate the general structure of such a reduction gear.

According to FIG. 1, a known starter 1 comprises an electric motor 2 comprising an armature which drives a shaft 3 carrying, at its free end, a pinion 4. A reduction gear 5 with epicyclic train 6 is interposed between the pinion 4 and a starter head shaft 7 coaxial with the output shaft 3 of the electric motor 2, the starter head 8 being movable on the shaft 7 by means of a lever 7 in the form of a fork of an electromagnetic contactor 11 disposed in the top part of the starter. The electric motor 2 and the reduction gear are enclosed in a casing 12 to which there is fixed a front part in the form of a cap 13 on which there is also mounted the housing 14 of the contactor 11. The cap 13 serves for fixing the starter 1 to the fixed part of the vehicle.

The reduction gear 5 comprises a base plate 16 fixed to the casing 12 and the housing 14, by screws 17 fixing the cap 13 to the casing 12 and the housing 14, and a ring 19 moulded onto the plate 16 in the starter shown. The plate 16 is interposed axially between on the one hand the cap and on the other hand the housing 14 and the casing 12.

The ring 19 comprises internal teeth 20 meshing with the planet wheels 21 of the epicyclic train 6. The planets are mounted on shafts 23 carried by a shaft-carrier plate 25 rotationally fixed to the starter head shaft 7 and immobilised axially in translation by a plate 26 force-fitted on the planet shafts 23.

Such an arrangement with a base plate mounted fixed in the starter is described in the document FR A 2 725 758 (U.S. Pat. No. 5,718,147). For more information reference can be made to this document.

The invention concerns specifically the production of the reduction gear ring of a starter with a base plate of the type depicted in FIG. 1.

A description will be given below of two embodiments of such a ring designated by the reference 30 in the two embodiments. These have in common the fact that the ring is produced in two parts, namely an external part 31, mounted fixed in the casing of the starter via the base plate 35, and an internal ring part 32 which is mounted coaxially with respect to the external part 31; a shock damping device 34 being interposed between the external part 31 and the ring member 32. The internal ring 32 is mounted so as to be able to move in rotation with respect to the external part 31 counter to the force exerted circumferentially by the damper members 42, 44, 53 which the device 34 has.

The top part 31 is fixed to the base plate 35, which therefore constitutes a support plate for this part 31 extending inside the casing 12 like the ring 19 in FIG. 1.

Advantageously the base plate 35 corresponds to the base plate 16 of the known starter of FIG. 1. The plate 35 therefore serves as a casing for the housing 14 of the contactor 11. It also serves for fixing the casing 12 to the cap 13 via the screws 17. This plate can also serve as a support for the articulation support (not referenced in FIG. 1) of the lever 9. The plate according to one characteristic closes off the open end of the casing 12. This end is adjacent to the cap 13.

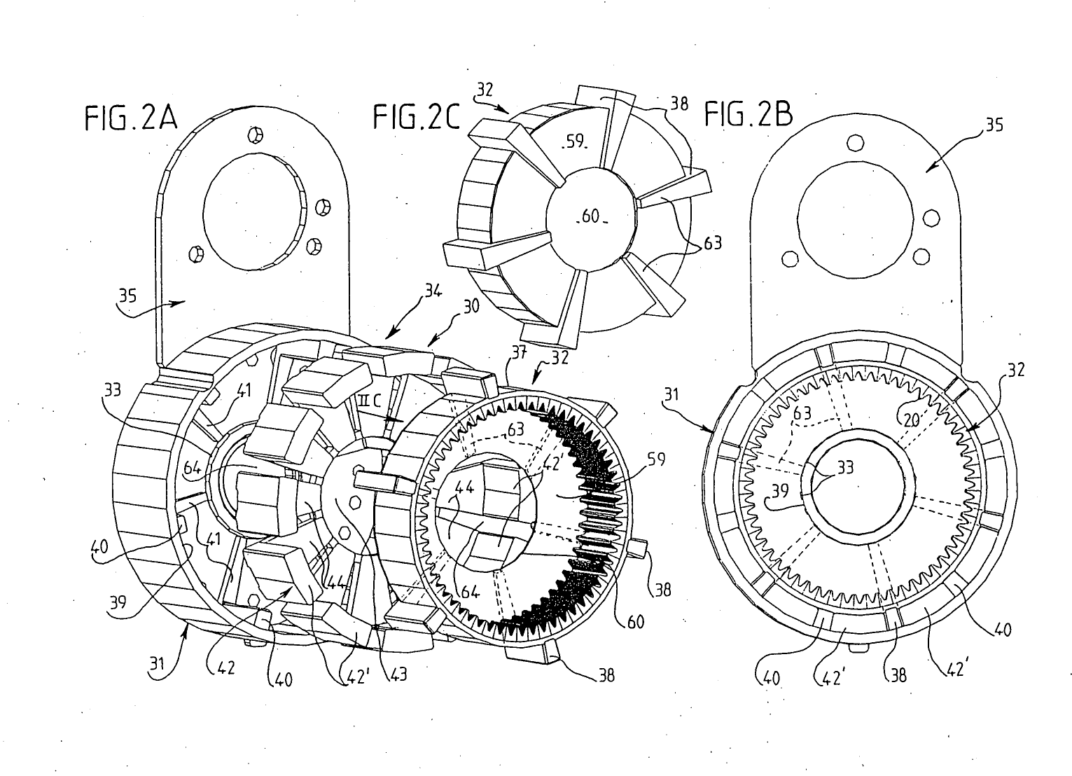

In the first embodiment depicted in FIGS. 2A and 2B, the external part 31 consists of a rigid housing made from plastics material. More precisely the housing is a housing in the form of a cylindrical ring 31 which is moulded onto a base plate 35, here metallic, corresponding to the base plate 13 of the known starter. The housing can also be snapped onto this base plate. The internal ring 32 is produced from a rigid material, made from plastics material or metal. Its external peripheral face 37 carries six stop ribs 38 which project radially towards the outside and are distributed in an angularly equidistant fashion on the periphery. The internal cylindrical surface 39 of the ring housing 31 carries six stop ribs 40 parallel to the axis of the reduction gear, which project radially towards the inside and are also distributed in an angularly equidistant fashion. Each rib 40 is extended over the base plate 35 by a radial rib 41. The height of the ribs 38 and 40 and the diameters of the internal cylindrical face 39 of the housing and of the external peripheral face 37 of the internal ring 32 are sized so that, in the assembled state, the ribs 38 of the ring 32 come substantially into contact, with the internal housing face 39 and the ribs 40, with the peripheral face 37 of the internal ring 32.

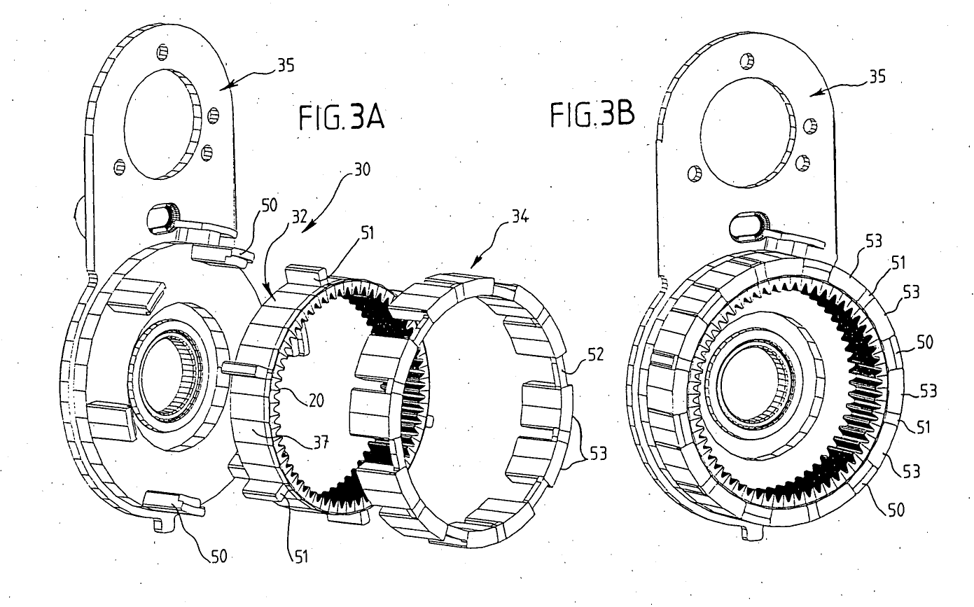

The base plate 35 comprises a central opening in the form of a hub 33 for the passage of the output shaft of the gearbox and the internal ring 32 is closed at its internal axial end by a wall 59 with the exception of a corresponding central opening 60. The base plate 35 comprises a series of openings (not visible). Advantageously the housing 31 is made from plastics material and is fixed by overmoulding to the plate 35 so that the plastic overmoulding material of the external housing 31 extends through the plate in order to constitute anchoring tenons for the housing 31. Here the openings consist of apertures angularly distributed in a regular manner around the central opening 33 in the plate. The apertures have the shape of an arc of a circle, as can be seen in FIG. 3 in the aforementioned document FR A 2 725 758.

Four apertures are therefore provided so that the anchoring tenons for the housing 31 are solid, whilst the number of planets 21 is three. All these arrangements reduce costs. Naturally, when the housing 31 is moulded on, the material extends through the aforementioned apertures in order to constitute an annular retaining disc on the other face of the plate 35. In this embodiment the plate has in its top part a hole for the fitting of a collar of the body 14 in FIG. 1. Such a hole is also visible in FIG. 3.

The damping device 35 comprises twelve shock damping members 42, for example made from elastomer, in particular rubber, which each have the shape of an L and are mounted around a common central support member 43, advantageously made from the same damping material and advantageously in the form of an annular plate, angularly equidistant from each other. Each damper member 42 in the form of an L comprises a damper block 42′ which extends parallel to the axis of the reduction gear, and a radial damper element 44 by means of which the damper member is fixed to the central plate. The damper device thus has the form of a ring and forms an assembly which can be handled and transported. Advantageously the damper device 34 is made in a single piece. In a variant the members 42 are attached to the annular-shaped support 43.

As shown by the figures, in the assembled state, each damper block 42′ is wedged in the annular space defined by the two ring parts, between a rib then forming a stop 38 for the internal ring 32 and a stop rib 40 for the housing 31, and each radial rib 41 is inserted between two radial damper elements 44.

Referring to FIG. 2C, it can be seen that the internal closure wall 59 of the internal ring 32 carries on its external face radial ribs 63 situated circumferentially at the stops 38 extending over the corresponding front face thereof. These ribs 63 are intended each to engage in the radial space 64 formed between two radial damper elements 44, which are situated between two radial ribs 41 of the ring housing 31.

The ribs 63 have an axial height greater than the axial thickness of the damper elements 44, which creates a free space between the internal radial face of the housing and the external face of the elements 44, to allow deformation of these elements.

By virtue of these design characteristics, the damper device 34 reduces the torsion shocks and axial shocks.

The second embodiment depicted in FIGS. 3A and 3B has the particularity that the external part, up to now formed by a housing closed over its periphery, is formed solely by six rigid tenons 50 which project perpendicularly from the base plate 35 and are distributed in an angularly equidistant fashion over a circle.

More precisely the axially oriented tenons 50 are moulded onto the plate by means of the aforementioned apertures in an arc of a circle in the plate 35. The number of apertures and tenons 50 is here six so that the apertures have a smaller size. This number depends on the application. The internal ring 32 is mounted coaxially with respect to the tenons 50 distributed on one and the same median circumference. This ring 32 carries at its external periphery 37 six relatively narrow external ribs 51 also distributed in an angularly equidistant fashion over its periphery. The ribs 51 project radially.

The damper device 34 forms an assembly which can be handled and transported as in the previous embodiment and is produced in the form of a ring comprising an annulus 52 advantageously made from the same damping material, on which six pairs of damper members 53 are disposed, each in the form of a block. The annulus 52 is disposed at one axial end of the blocks. The distance in the peripheral direction of the damper between the blocks in one pair is equal to the width of a groove 51 in the internal ring 32 whilst the difference between two pairs of blocks is substantially equal to the width of a tenon 50 on the base plate. FIG. 3B shows that, in the assembled state, the tenons 50, the ribs 51 and the blocks 53 form an assembly in which a pair of damper blocks 53 is wedged angularly between two tenons 50 on the base plate and each rib 51 on the internal ring is inserted between the two blocks 53 of each pair of blocks, the centering of the internal ring 32 being accomplished by the tenons 50. It should be noted that the plate 35 also has a single hole, non-circular in shape, for fixing a plastic articulation support for the lever 9 in FIG. 1. This support is fixed by moulding onto the plate 35; the overmoulding material of this support extending through a single hole for anchoring the articulation support.

It is obvious that the configuration of the damper members or blocks in a ring has the advantage of reducing the number of parts and simplifying the assembly whilst providing effective damping of tangential shocks.

It should also be noted that the axial length of the tenons 50 is slightly greater than the axial length of the damper blocks 53 in order to obtain a free space allowing the deformation of these blocks and thus enabling these blocks to fulfil their damping function under the effect of radial loads.

Naturally the number of damper members 42, 53 of the stop projections 40, 41, 50 and stop ribs 38, 51 depends on the application. In all cases the members 42, 53 are fixed to the plate 43, in the form of an annulus, or to the annulus 52. Naturally the plate in FIGS. 2A and 2C has in a variant the single fixing hole for the articulation support of the lever 9. This plate in a variant does not serve as a support for the lever 9 and contactor 11. In all cases it closes off the casing 12 housing the electric motor 2.

In a variant the tenons 50 are fixed by crimping to the plate 35. Each tenon has for example a narrower anchoring lug in order to form a shoulder. The lugs passing through the aforementioned apertures in the plate 35 and the material of these is folded over in contact with the other face of the plate for example by hot deformation when the tenons 50 are made from plastics material or cold when the tenons 50 are metallic. The apertures are advantageously rectangular in shape with a cross-section complementary to that of the anchoring lugs. In a variant the anchoring lugs are welded after passing through the apertures. These types of fixing with shouldered lugs can be envisaged in the embodiment in FIGS. 2A to 2C; the housing being metallic in a variant.

It will be appreciated that the plate 35 makes it possible to wedge the internal ring 32 axially in one direction and that the external part 31 has a simpler shape than that of the aforementioned document U.S. Pat. No. 4,680,979.

The size of the ring 30 is not imposed by the casing and depends on the application.

The damper members 42, 44, 53 as well as the support members 43, 52 are made from damping material in the aforementioned manner, being for example based on elastomer or rubber, possibly containing fillers.

1. Motor vehicle starter provided with a casing (12) and a reduction gear (5) with an epicyclic train (6) comprising planet wheels (21), a ring (30), which comprises an external part (31) mounted fixed in the casing of the starter and an internal ring part (32) mounted coaxially in the external part and carrying internal teeth meshing with the planet wheels of the reduction gear, and shock damping members interposed between the external part of the ring of the reduction gear and the internal ring, in which the damper members (42, 44; 53) are arranged in a circular ring configuration coaxial with the axis of the reduction gear on a support member (43; 52) able to be placed between the external reduction gear part (31, 50) and the internal reduction gear ring (32), characterised in that the starter casing (12) has an open end closed by a base plate (35) mounted fixed in the starter and in that the external part (30) of the ring (30) is fixed to the base plate.

2. Reduction gear according to claim 1, characterised in that the aforementioned support member of the damping members is formed by a common central element (43) and in that each damper member (42) has the form of an L comprising a damper block (42) extending parallel to the axis of the reduction gear and a radial damper element (44) fixed to the central support.

3. Reduction gear according to claim 2, characterised in that the external ring part is produced in the form of a ring (31) forming a cylindrical housing carrying on its internal peripheral face (39) stop projections (40) and the external peripheral face (37) of the internal reduction gear ring (32) carries radial ribs (38), each damper block (42) being inserted between the opposite radial faces of a stop projection (40) on the housing and a radial rib (38) on the internal reduction gear ring (32).

4. Reduction gear according to claim 3, characterised in that a free space allowing the deformation of the radial damper elements (44) is provided in the external reduction gear ring (31).

5. Reduction gear according to claim 1, characterised in that the external ring part is formed by a plurality of tenons (50) extending axially from the base plate (35) mounted fixed in the starter and distributed in an angularly equidistant fashion on a circle coaxial with the axis of the reduction gear, and whose lateral faces constitute the lateral stop faces of the damper block (53).

6. Reduction gear according to claim 5, characterised in that the support member for the damper members is formed by an annulus (52) on which the damper blocks are mounted at one axial end.

7. Reduction gear according to claim 6, characterised in that the axial length of the tenons (50) is slightly greater than the axial length of the damper blocks (53) in order to create a free space allowing the elastic deformation of the latter.
